(19) United States
(12) Patent Application Publication
(10) Pub. No.: US 2026/0279020 A1
(43) Pub. Date: Sep. 17, 2026

(54) SYSTEM AND METHOD FOR GENERATING AI TRAINING IMAGE DATA FOR AUTONOMOUS DRIVING

(71) Applicants: HYUNDAI MOBIS CO., LTD., Seoul (KR); Korea University Research and Business Foundation, Seoul (KR)

(72) Inventors: Heon Jeong CHU, Yongin-si (KR); Yeong Seok KIM, Yongin-si (KR); Joon Hyung PARK, Yongin-si (KR); Seungryong KIM, Seoul (KR)

(73) Assignees: HYUNDAI MOBIS CO., LTD., Seoul (KR); Korea University Research and Business Foundation, Seoul (KR)

(21) Appl. No.: 19/374,476

(22) Filed: Oct. 30, 2025

(30) Foreign Application Priority Data
Nov. 28, 2024 (KR) 10-2024-0173267

(51) Int. Cl. G06V 10/774; G06N 3/0455; G06N 3/0475; G06N 3/08; G06T 7/13; G06T 11/60

(52) U.S. Cl. CPC G06V 10/774; G06N 3/0455; G06N 3/0475; G06N 3/08; G06T 7/13; G06T 11/60

(57) ABSTRACT

The present disclosure relates to a system and method for generating AI training image data for autonomous driving. The system for generating artificial intelligence (AI) training image data for autonomous driving includes: a processor configured to receive and process synthetic data including shape information of a target object to be generated, extract segmentation information and edge information from the synthetic data, and input the extracted segmentation information and edge information into a pre-stored learning model to generate style-transformed image data based on the synthetic data.

### CROSS REFERENCE TO RELATED APPLICATION

The present application claims priority to Korean Patent Application No. 10-2024-0173267, filed on Nov. 28, 2024, the entire contents of which is incorporated herein for all purposes by this reference.

### BACKGROUND OF THE DISCLOSURE

### Field of the Disclosure

The present disclosure relates to a system and method for generating artificial intelligence (AI) training image data for autonomous driving, and more particularly, to a system and method for generating AI training image data for autonomous driving capable of enhancing the performance of image recognition algorithms for autonomous driving by expanding datasets and improving the quality of synthetic images (virtual images) through converting synthetic images into high-quality images using an AI-based diffusion model.

### Description of the Related Art

Image-to-Image (I2I) conversion technology transforms images from one domain to another, with Generative Adversarial Networks (GANs) being a key technique.

GANs consist of a generator, which creates virtual images, and a discriminator, which distinguishes between generated and real images, enabling the generator to learn to produce more realistic images based on the discriminator's feedback.

The primary goal of I2I technology is to improve the quality of domain-converted images while naturally reflecting various styles and details, leading to the introduction of new networks, training methods, and diverse datasets.

Simulations based on this I2I technology generate synthetic images to address limitations in real-image-based autonomous driving training.

However, a domain gap between synthetic (virtual) and real images reduces the accuracy of trained models.

Specifically, conventional I2I conversion techniques cause fidelity degradation and loss of original image details during transformation.

For example, the lack of precise guidance during conversion can result in unintended artifacts or instance distortions in output images.

Moreover, GAN models require extensive hyperparameter tuning for optimization and may encounter issues like model collapse, leading to failures in securing data diversity, thus presenting clear limitations in improving the quality of autonomous driving training image data despite advancements in I2I conversion technology.

In this regard, Korean Patent Publication No. 10-2024-0106099 (“Apparatus and Method for Generating Training Data”) discloses a technique for generating similar training data without accessing original training data.

### DOCUMENTS OF RELATED ART

(Patent Document 1) Korean Patent Publication No. 10-2024-0106099 (Jul. 8, 2024)

### SUMMARY OF THE DISCLOSURE

The present disclosure has been conceived to solve the above problems, and it is an object of the present disclosure to provide a system and method for generating AI training image data for autonomous driving, which are capable of improving the quality and diversity of synthetic data to overcome limitations in acquiring synthetic images for corner and edge cases due to constraints in training data collection environments, thereby facilitating the learning and validation of image recognition algorithms even in such challenging scenarios, whereas training and verification for typical driving environments can be performed more easily.

In order to accomplish the above objects, a system for generating artificial intelligence (AI) training image data for autonomous driving according to the present disclosure preferably includes a data input unit configured to receive and process synthetic data including shape information of a target object to be generated; a data preprocessing unit configured to extract segmentation information and edge information from the synthetic data; and a data generation unit configured to input the extracted segmentation information and edge information into a pre-stored learning model to generate style-transformed image data based on the synthetic data.

Preferably, the system for generating AI training image data for autonomous driving further includes a data collection unit configured to generate a training dataset by collecting synthetic data including shape information of a target object to be generated using simulations and real image data acquired from the real world, for training the learning model stored in the data generation unit, a condition processing unit including a conditional encoder configured to extract segmentation information and edge information from the synthetic data in the generated training dataset and encode the extracted information, and a control neural network configured to generate control information based on the encoded conditional data, a reference processing unit including a CLIP encoder configured to encode the real image data in the training dataset to generate reference information, and a fine-tuning processing unit configured to fine-tune a stored diffusion model by combining the reference information generated by the reference processing unit with each encoder block of the diffusion model, and combining the condition information generated by the condition processing unit with each decoder block of the diffusion model.

Preferably, the diffusion model, fully trained by the fine-tuning processing unit, is stored in the data generation unit and used as the learning model.

Preferably, each encoder block of the fine-tuning processing unit includes a self-attention layer, a cross-attention layer, and an adaptive instance normalization (AdaIN) layer, and is configured for the reference information, including key and value information generated by the reference processing unit, to be combined with a query in the cross-attention layer and transmitted to the AdaIN layer, and the cross-attention layer generating reference information to be input into the AdaIN layer using an attention map produced through the combination of the query, key, and value information.

Preferably, the fine-tuning processing unit controls image generation by weighting and combining the control information generated by the condition processing unit with each decoder block.

Preferably, the data collection unit generates the training dataset based on preset weather conditions, and the diffusion model, fully trained by the fine-tuning processing unit, is trained to reflect characteristics of each weather condition.

Preferably, the fine-tuning processing unit calculates a loss function for the generated images and performs training to minimize the calculated loss value.

In order to accomplish the above objects, a method for generating artificial intelligence (AI) training image data for autonomous driving using an autonomous driving AI training image data generation system including one or more processors performing each operation preferably includes a data input operation (S100) of receiving and processing, by the data input unit, synthetic data including shape information of a target object to be generated, a data preprocessing operation (S200) of extracting, by the data preprocessing unit, segmentation information and edge information from the synthetic data obtained in the data input operation (S100), and a data generation operation (S300) of generating, by the data generation unit, style-transformed image data based on the synthetic data by inputting the segmentation information and edge information extracted in the data preprocessing operation (S200) into the pre-stored learning model.

Preferably, the method for generating AI training image data for autonomous driving further includes, prior to the data generation operation (S300), a learning model pre-training operation, wherein the learning model pre-training operation includes a data collection operation (S10) of generating, by the data collection unit, a training dataset by collecting synthetic data including shape information of a target object to be generated using simulations and real image data acquired from the real world, a condition processing operation (S20) of extracting and encoding, by the condition processing unit, segmentation information and edge information from the synthetic data in the generated training dataset using the conditional encoder, and generating control information based on the encoded conditional data using the control neural network, a reference processing operation (S30) of encoding, by the reference processing unit, the real image data in the training dataset using the CLIP encoder to generate reference information, and a fine-tuning processing operation (S40) of fine-tuning, by the fine-tuning processing unit, a stored diffusion model by combining the reference information generated in the reference processing operation (S30) with each encoder block of the diffusion model and combining the control information generated in the condition processing operation (S20) with each decoder block of the diffusion model, wherein the fine-tuning processing operation (S40) preferably includes calculating a loss function for the generated images and performing training to minimize the calculated loss value, and the diffusion model, fully trained in the fine-tuning processing operation (S40), is preferably used as the learning model in the data generation operation (S300).

Preferably, the fine-tuning processing operation (S40) includes, for each encoder block including a self-attention layer, a cross-attention layer, and an adaptive instance normalization (AdaIN) layer, processing the reference information, including key and value information generated in the reference processing operation (S30), to be combined with a query in the cross-attention layer and transmitted to the AdaIN layer, the cross-attention layer generating reference information to be input into the AdaIN layer using an attention map produced through the combination of the query, key, and value information.

Preferably, the fine-tuning processing operation (S40) includes controlling image generation by weighting and combining the control information generated in the condition processing operation (S20) with each decoder block.

Preferably, the data collection operation (S10) includes generating the training dataset based on preset weather conditions, and the diffusion model, fully trained in the fine-tuning processing operation (S40) being trained to reflect characteristics of each weather condition.

### BRIEF DESCRIPTION OF THE DRAWINGS

FIG. 1 is a diagram illustrating the configuration of a system for generating AI training image data for autonomous driving according to an embodiment of the present disclosure;

FIG. 2 is a configuration diagram illustrating the configuration of a learning model applied to a system and method for generating AI training image data for autonomous driving according to an embodiment of the present disclosure; and

FIG. 3 is a flowchart illustrating a method for generating AI training image data for autonomous driving according to an embodiment of the present disclosure.

### DETAILED DESCRIPTION OF THE DISCLOSURE

The foregoing objectives, features, and advantages of the present disclosure will be more clearly understood through the following detailed description, taken in conjunction with the accompanying drawings.

The specific structural or functional descriptions below are merely illustrative examples intended to describe embodiments of the present disclosure, and the embodiments of the present disclosure may be implemented in various forms and should not be construed as limited to those described in this specification or the application.

The embodiments of the present disclosure may be subject to various modifications and may take on many different forms; therefore, specific embodiments are illustrated in the drawings and described in detail in this specification or the application.

However, this should not be construed as limiting the embodiments of the present disclosure to the specific disclosed form, but should rather be understood to encompass all modifications, equivalents, or substitutes that fall within the scope of the concept and technological scope of the disclosure.

The terms such as “first” and/or “second” may be used to describe various components, but the components are not limited to these terms.

These terms are used solely for the purpose of distinguishing one component from another, so that, for example, the first component may be referred to as the second component without departing from the scope of the present disclosure, and similarly, the second component may also be referred to as the first component.

When it is stated that a component is connected to or coupled to another component, it should be understood that the component may be directly connected to or coupled to the other component, or there may be other components interposed therebetween.

On the other hand, when it is stated that a component is directly connected to or coupled with another component, it should be understood that there are no intermediate components between them.

Other expressions used to describe the relationship between components, such as “between” and “directly between,” or “adjacent to” and “directly adjacent to,” should be interpreted in the same manner.

The terms used in this specification are merely for the purpose of describing specific embodiments and are not intended to limit the present disclosure.

The singular forms are intended to include the plural forms as well unless the context clearly indicates otherwise.

The terms “include” or “comprise” used in this specification are intended to specify the presence of the described features, numbers, steps, actions, components, parts, or combinations thereof, and should not be understood as excluding the possibility of additional features, numbers, steps, actions, components, parts, or combinations thereof.

Unless otherwise defined herein, all terms including technical or scientific terms used herein have the same meanings as commonly understood by those skilled in the art to which the present disclosure belongs.

It will be further understood that terms, such as those defined in commonly used dictionaries, should be interpreted as having a meaning that is consistent with their meaning in the context of the relevant art and should not be interpreted in an idealized or overly formal sense unless expressly so defined herein.

To provide a detailed explanation of the present disclosure, preferred embodiments thereof will hereinafter be described with reference to the accompanying drawings.

Like reference numerals refer to like elements throughout the drawings.

In addition, the term “system” refers to a collection of components, devices, mechanisms, or means that are organized and interact in a regular manner to perform the required functions.

A system and method for generating AI training image data for autonomous driving according to an embodiment of the present disclosure relate to a technology for enhancing the image quality of synthetic (virtual) images and securing data diversity through virtual images, by providing photorealistic rendering and style transformation of virtual images in line with the technological development trend of autonomous driving recognition algorithms shifting toward a data-driven approach.

In particular, the technology is advantageous for improving the conversion accuracy of so-called “content-rich scenes,” which include diverse and complex details or elements used in autonomous driving.

Additionally, it relates to a technology that enables the generation of user-conceived and intended scenes by improving the randomness of object conversion within an image, and that overcomes limitations in encoding interactions and relationships between pixels due to the inherent receptive field constraints of image generation networks (e.g., CNNs).

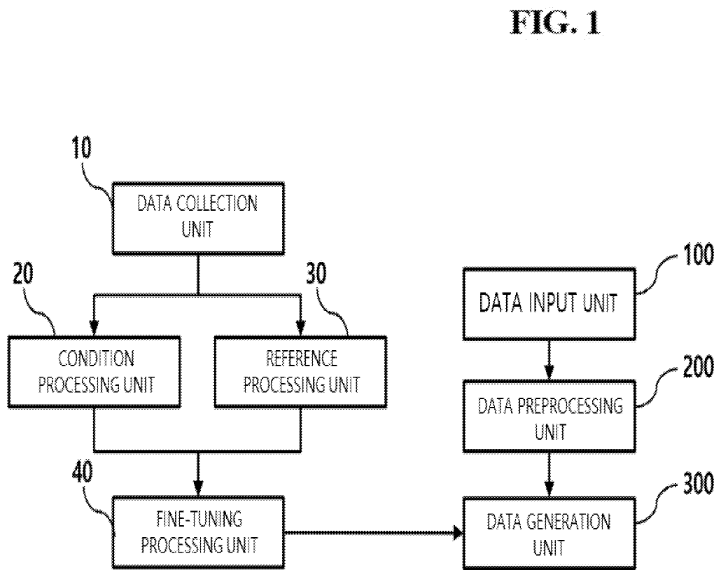

FIG. 1 is a diagram illustrating the configuration of a system for generating AI training image data for autonomous driving according to an embodiment of the present disclosure, and a detailed description will be provided of the system for generating AI training image data for autonomous driving according to an embodiment of the present disclosure with reference to FIG. 1.

According to an embodiment of the present disclosure, a system for generating AI training image data for autonomous driving includes a data input unit 100, a data preprocessing unit 200, and a data generation unit 300, as shown in FIG. 1. The system according to an exemplary embodiment of the present disclosure may include a processor (e.g., computer, microprocessor, CPU, ASIC, circuitry, logic circuits, etc.) and an associated non-transitory memory storing software instructions which, when executed by the processor, provides the functionalities of the data input unit 100, the data preprocessing unit 200, and the data generation unit 300. Herein, the memory and the processor may be implemented as separate semiconductor circuits. Alternatively, the memory and the processor may be implemented as a single integrated semiconductor circuit. The processor may embody one or more processor(s).

Each component may be a part of a single computing means, such as a computer, or distributed across a plurality of computing means to perform corresponding operations.

In more detail, the data input unit 100 may be configured to receive and process synthetic data (virtual data) including shape information of target objects to be generated, the synthetic data being generated via computing means such as a computer.

That is, for the development of image recognition algorithms for autonomous driving, the input synthetic data contains shape information of various target objects generated through simulations by the computing means (e.g., vehicles, pedestrians, roads, traffic lights, crosswalks, and roadside trees).

The data preprocessing unit 200 extracts segmentation information and edge information from the synthetic data received through the data input unit 100.

The segmentation information is used to more clearly distinguish the target objects to be generated, and the edge information is used to reflect lane information.

More specifically, the data preprocessing unit 200 labels each target object to extract segmentation information by class in order to extract key structural information when converting a content-rich scene into an image.

In addition, the edge information is extracted to reflect the lane information.

Here, the data preprocessing unit 200 of the present disclosure applies Grounded-SAM (Segment Anything Model), which is one of the labeling models; however, it is not limited thereto, and any model capable of performing labeling with the desired level of performance or higher may be used.

The data generation unit 300 preferably generates style-transformed image data based on the synthetic data by inputting the segmentation information and edge information, extracted through the data preprocessing unit 200, into a pre-stored learning model.

Specifically, the data generation unit 300 constructs the shape information of the style-transformed image data based on the segmentation and edge information, and when the segmentation and edge information are input into a pre-stored learning model trained for each weather condition, the shape information serves as a constraint, allowing the generation of style-transformed image data adapted to various weather conditions based on the characteristics of the diffusion model while preserving object contours.

To this end, the system for generating AI training image data for autonomous driving according to an embodiment of the present disclosure performs pre-training of the learning model stored in the data generation unit 300.

As shown in FIG. 1, the system further includes a data collection unit 10, a condition processing unit 20, a reference processing unit 30, and a fine-tuning processing unit 40. As discussed above, the system may include a processor (e.g., computer, microprocessor, CPU, ASIC, circuitry, logic circuits, etc.) and an associated non-transitory memory storing software instructions which, when executed by the processor, provides the functionalities of the data collection unit 10, the condition processing unit 20, the reference processing unit 30, and the fine-tuning processing unit 40. In some embodiments, the condition processing unit 20 may be referred to as a condition processor. In some embodiments, the reference processing unit 30 may be referred to as a reference processor. In some embodiments, the fine-tuning processing unit 40 may be referred to as a fine-tuning processor.

Each component may be implemented as part of a single computing means, such as a computer, or distributed across multiple computing means to perform operations.

The data collection unit 10 collects real image data actually acquired and synthetic data (virtual data) including object shapes generated using simulations to construct a training dataset.

Here, the real image data refers to image data acquired through a camera sensor or the like, and the synthetic data refers to image data including virtual object shapes generated through simulations by computing means such as a computer.

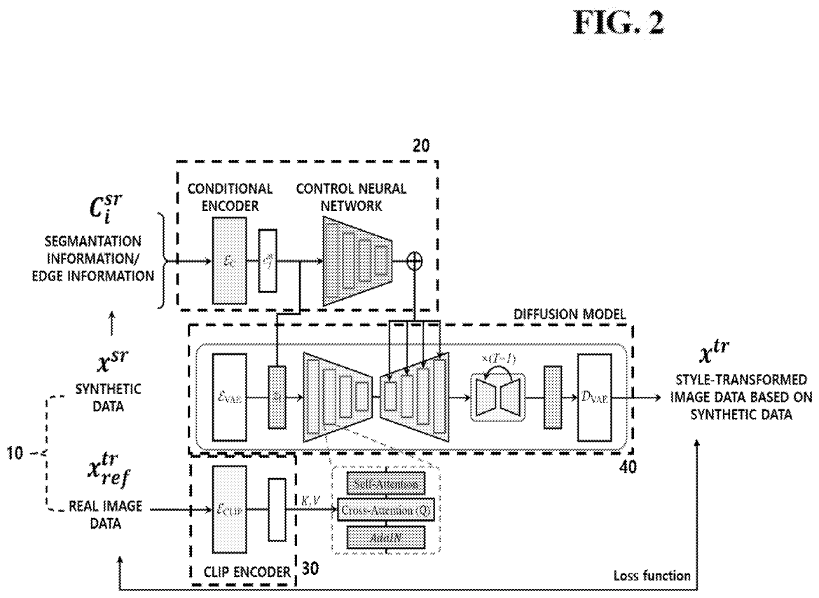

The condition processing unit 20, the reference processing unit 30, and the fine-tuning processing unit 40 perform training on the dataset generated by the data collection unit 10, and are preferably configured in a layered structure of a learning model as shown in FIG. 2.

The condition processing unit 20, reference processing unit 30, and fine-tuning processing unit 40 use the diverse and extensive real image data and synthetic data from the training dataset created by the data collection unit 10 to train on image characteristics.

As shown in FIG. 2, to reflect the characteristics of real image data, the real image data is input into a Contrast Language-Image Pre-training (CLIP) encoder, and the resulting encoding information is fed into the encoder block of the diffusion model, enabling the noise processing during encoding to incorporate the style characteristics of the real image data.

Additionally, segmentation and edge information derived from synthetic data are input into the decoder block of the diffusion model to preserve the structural characteristics of object shape information.

The output of the diffusion model is evaluated using a stored loss function to calculate a loss value, comparing the distribution difference with real image data and iteratively training to minimize the loss, making it more realistic.

In the present disclosure, two types of loss functions are employed to guide the model toward an optimal balance by simultaneously considering the respective objectives of each loss function.

That is, when the two loss functions are optimized separately, training may become biased toward one of them, potentially resulting in a transformation (prediction) that focuses solely on either preserving the object shape information from the synthetic data or reflecting the style characteristics of the real image data learned by the diffusion model.

Therefore, in the present disclosure, a well-balanced loss function is established by combining the two loss functions, as defined in Equation 1 below.

$$\text{?} \qquad Equation 1$$

$$\text{?} \text{indicates text missing or illegible when filed}$$

(Here , , , and λ are weighting constants.)

Based on this, in more detail regarding the training model, the condition processing unit 20 preferably includes a conditional encoder configured to extract and encode segmentation and edge information from the synthetic data within the training dataset generated by the data collection unit 10, and a control neural network (control net) configured to generate control information based on the encoded conditional data.

The control neural network is a technique that utilizes a diffusion model to generate various images based on the structural context of an image.

For transforming content-rich scenes, such as synthetic data, segmentation information for each class is extracted by labeling each target object included in the synthetic data in order to extract key structural information.

In addition, the edge information is extracted to reflect the lane information.

Here, the data preprocessing unit 200 of the present disclosure applies Grounded-SAM (Segment Anything Model), which is one of the labeling models; however, it is not limited thereto, and any model capable of performing labeling with the desired level of performance or higher may be used.

The reference processing unit 30 preferably includes a CLIP encoder configured to encode real image data within the training dataset generated by the data collection unit 10 to generate reference information.

Unlike conventional diffusion models that use a CLIP Text Encoder for text conditioning to extract text embeddings, the present disclosure uses real image data as a reference to control the weather conditions of the target image, and thus employs a CLIP Image Encoder instead.

Subsequently, the CLIP encoder extracts reference image embeddings, analogous to text embeddings, which are then provided as Key and Value information to each encoder block of the fine-tuning processing unit.

This will be elaborated on later.

The fine-tuning processing unit 40 preferably fine-tunes the diffusion model by combining the reference information generated by the reference processing unit 30 at each encoder block of the stored diffusion model and the conditional information generated by the condition processing unit 20 at each decoder block.

That is, the weights of the U-Net module in the layered structure of the diffusion model are trained to optimize the model to the data distribution of realistic images.

To naturally learn the distribution of real image data, which is the target domain, a Generative Adversarial Network (GAN) loss function is added to the reconstruction loss function, as mentioned above in Equation 1.

While the reconstruction loss aims to accurately reconstruct the data, the GAN loss enables the generation of more natural and higher-quality images by making the generated data appear more realistic.

As shown in FIG. 2, each encoder block of the fine-tuning processing unit 40 includes a self-attention layer, a cross-attention layer, and an Adaptive Instance Normalization (AdaIN) layer, and is configured such that the key and value information, which is the reference information generated by the reference processing unit 30, is combined with the query of the cross-attention layer and then delivered to the AdaIN layer.

The cross-attention layer generates the reference information to be input into the AdaIN layer by creating an attention map through the combination of the query, key, and value information.

That is, to enhance the effectiveness of style reflection, it is preferable to include the AdaIN layer in place of the conventional layer normalization.

Here, a key advantage is the ability to effectively reflect the characteristics of the target image (from the training dataset), by extracting the distribution characteristics of the target image data and enhancing the transformation effect through reflecting the object information (segmentation and edge information) and style information (key and value) of the target image in the distribution characteristics of the input image via scaling and shifting.

In this way, the AdaIN layer enables flexible reflection of various styles.

Additionally, the fine-tuning processing unit 40 controls image generation by combining each conditional input generated by the condition processing unit 20 as weights into each decoder block.

Through this process, the diffusion model that has been final-trained by the fine-tuning processing unit 40 is stored in the data generation unit 300 and used as the trained model.

Preferably, the data collection unit 10 generates a training dataset according to pre-set weather conditions.

Accordingly, the diffusion model that is finally trained by the fine-tuning processing unit 40 is trained to reflect the characteristics of each weather condition.

Specifically, when the synthetic image and corresponding object information (segmentation and edge information) from the data input unit 100 are input into the trained model (final-trained diffusion model), the data generation unit 300 outputs style-transformed image data that reflects the characteristics of the weather condition of the respective diffusion model, based on the object information.

Here, the term ‘weather condition’ includes not only sunny, rainy, and night conditions but also fog, winter, and other external driving conditions.

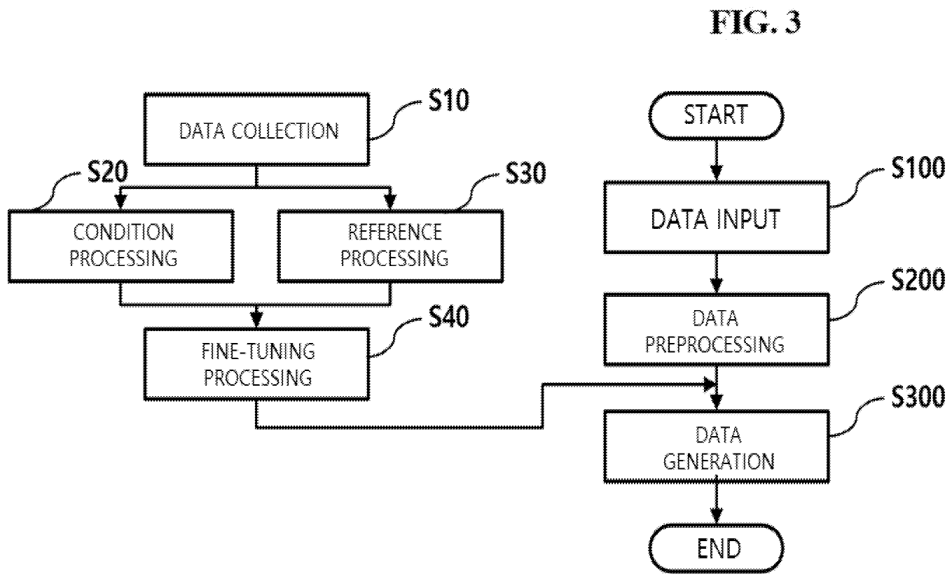

FIG. 3 is a flowchart illustrating a method for generating AI training image data for autonomous driving according to an embodiment of the present disclosure, and a detailed description will be provided of the AI training image data generation method for autonomous driving according to an embodiment of the present disclosure with reference to FIG. 3.

A method for generating AI training image data for autonomous driving according to an embodiment of the present disclosure includes inputting data in operation S100, preprocessing the data in operation S200, and generating the data in operation S300, as shown in FIG. 3.

Each operation is performed using an AI training image data generation system for autonomous driving, which is implemented by computing means such as a computer.

Regarding each operation in detail, in operation S100 of data inputting, the data input unit 100 receives and processes synthetic data (virtual data), which contains shape information of target objects and is generated by computing means such as a computer.

That is, for the development of image recognition algorithms for autonomous driving, the input synthetic data contains shape information of various target objects generated through simulations by the computing means (e.g., vehicles, pedestrians, roads, traffic lights, crosswalks, and roadside trees).

In operation S200 of data preprocessing, the data preprocessing unit 200 extracts segmentation and edge information from the synthetic data obtained in the data input operation S100.

The segmentation information is used to more clearly distinguish the target objects to be generated, and the edge information is used to reflect lane information.

For transforming content-rich scenes, segmentation information for each class is extracted by labeling each target object included in the synthetic data to obtain key structural information.

In addition, the edge information is extracted to reflect the lane information.

Here, the data preprocessing unit 200 of the present disclosure applies Grounded-SAM (Segment Anything Model), which is one of the labeling models; however, it is not limited thereto, and any model capable of performing labeling with the desired level of performance or higher may be used.

In operation S300 of data generation, the data generation unit 300 generates style-transformed image data based on synthetic data by inputting the segmentation and edge information extracted in the data preprocessing operation S200 into a pre-stored training model.

Specifically, in the data generation operation S300, the shape information of the style-transformed image data is configured based on the segmentation and edge information, and since the pre-stored training models are trained for respective weather conditions, when the segmentation and edge information are input to a training model corresponding to a desired weather condition, the shape information based on the segmentation and edge information is given as a constraint so that the contours of the objects are preserved while generating style-transformed image data that reflects the characteristics of the diffusion model according to the specific weather condition.

The method for generating AI training image data for autonomous driving according to an embodiment of the present disclosure further includes, prior to performing the data generation operation S300, a data collection operation S10, a condition processing operation S20, a reference processing operation S30, and a fine-tuning processing operation S40, in order to pre-train the learning model, as shown in FIG. 3.

In the data collection operation S10, the data collection unit 10 collects synthetic data (virtual data), including object shapes generated using real-world image data and simulations, thereby generating a training dataset.

Here, the real image data refers to image data acquired through a camera sensor or the like, and the synthetic data refers to image data including virtual object shapes generated through simulations by computing means such as a computer.

In the condition processing operation S20, the condition processing unit 20 extracts segmentation information and edge information from the synthetic data within the training dataset generated in the data collection operation S10, and generates control information based on a conditional encoder that encodes the extracted conditional data.

Here, the control information is generated through a control neural network (ControlNet), which is a technique that utilizes a diffusion model to generate various images based on the structural context of the image.

For transforming content-rich scenes, such as synthetic data, segmentation information for each class is extracted by labeling each target object included in the synthetic data in order to extract key structural information.

In addition, the edge information is extracted to reflect the lane information.

Here, the data preprocessing unit 200 of the present disclosure applies Grounded-SAM (Segment Anything Model), which is one of the labeling models; however, it is not limited thereto, and any model capable of performing labeling with the desired level of performance or higher may be used.

In the reference processing operation S30, the reference processing unit 30 encodes real-world image data within the training dataset generated in the data collection operation S10 to generate reference information.

Unlike conventional diffusion models that use a CLIP Text Encoder to extract text embeddings for text conditioning, the present disclosure employs a CLIP Image Encoder in the reference processing operation S30, as it uses real image data as a reference to control the weather conditions of the target image.

The CLIP encoder extracts reference image embeddings, analogous to text embeddings, which are then input as Key and Value information to each encoder block of the fine-tuning processing unit.

This will be elaborated on later.

In the fine-tuning processing operation S40, the fine-tuning processing unit 40 fine-tunes the diffusion model by combining reference information generated in the reference processing operation S30 with each encoder block of the pre-stored diffusion model, and combining condition information generated in the condition processing operation S20 with each decoder block.

More specifically, in the fine-tuning processing operation S40, for each encoder block including a self-attention layer, a cross-attention layer, and an Adaptive Instance Normalization (AdaIN) layer, the reference information, i.e., the Key and Value data, generated in the reference processing operation S30 is combined with the Query of the cross-attention layer and then passed to the AdaIN layer.

Through this process, the cross-attention layer generates reference information to be input to the AdaIN layer by using the attention map formed from the combination of the Query, Key, and Value.

That is, to enhance the effectiveness of style reflection, it is preferable to include the AdaIN layer in place of the conventional layer normalization.

Here, a key advantage is the ability to effectively reflect the characteristics of the target image (from the training dataset), by extracting the distribution characteristics of the target image data and enhancing the transformation effect through reflecting the object information (segmentation and edge information) and style information (key and value) of the target image in the distribution characteristics of the input image via scaling and shifting.

In this way, the AdaIN layer enables flexible reflection of various styles.

In addition, the weights of the U-Net module in the layered structure of the diffusion model are trained to optimize the model to the data distribution of realistic images.

To naturally learn the distribution of the real-world image data, which is the target domain, a Generative Adversarial Network (GAN) loss function is added to the reconstruction loss function.

While the reconstruction loss aims to accurately reconstruct the data, the GAN loss enables the generation of more natural and higher-quality images by making the generated data appear more realistic.

Specifically, in the present disclosure, two types of loss functions are employed to guide the model toward an optimal balance by simultaneously considering the respective objectives of each loss function.

That is, when the two loss functions are optimized separately, training may become biased toward one of them, potentially resulting in a transformation (prediction) that focuses solely on either preserving the object shape information from the synthetic data or reflecting the style characteristics of the real image data learned by the diffusion model.

Therefore, in the present disclosure, the two loss functions defined as in Equation 1 are combined to construct a well-balanced loss function.

In summary, the present disclosure is configured to reflect the characteristics of real-world image data by inputting the real-world image data into a CLIP encoder, providing the resulting encoding information to the encoder blocks of the diffusion model, and enabling the style characteristics of the real-world image data to be reflected in the noise processing during encoding by the diffusion model.

Additionally, segmentation and edge information derived from synthetic data are input into the decoder block of the diffusion model to preserve the structural characteristics of object shape information.

The output of the diffusion model is evaluated using a stored loss function to calculate a loss value, comparing the distribution difference with real image data and iteratively training to minimize the loss, making it more realistic.

In addition, in the fine-tuning processing operation S40, each condition information generated in the condition processing operation S20 is combined as a weight with each decoder block to control image generation.

Through this process, the diffusion model that is finally trained in the fine-tuning processing operation S40 is used as the learning model in the data generation operation S300.

Here, the data collection operation S10 generates a training dataset according to a preset weather condition.

Accordingly, the diffusion model that is finally trained in the fine-tuning processing operation S40 is trained to reflect the characteristics of each weather condition.

More specifically, when the synthetic image along with the corresponding object information (segmentation information and boundary information) is input to the learning model (i.e., the diffusion model finally trained) through the data input operation S100 and the data pre-processing operation S200, the data generation operation S300 outputs style-converted image data based on the object information, with the weather condition characteristics of each diffusion model reflected.

Here, the term ‘weather condition’ includes not only sunny, rainy, and night conditions but also fog, winter, and other external driving conditions.

Meanwhile, the present disclosure described above may be implemented as computer-readable codes on a medium on which a program is recorded.

A computer-readable medium includes all types of recording devices in which data that can be read by a computer system is stored.

Examples of the computer-readable medium include a hard disk drive (HDD), solid state disk (SSD), silicon disk drive (SDD), read-only memory (ROM), random access memory (RAM), compact disc-read-only memory (CD-ROM), magnetic tape, floppy disk, optical data storage devices, and also include implementations in the form of carrier waves (e.g., transmission over the Internet).

Additionally, the computer may include the AI training image data generation system for autonomous driving according to the present disclosure.

A system and method for generating AI training image data for autonomous driving according to the present disclosure are advantageous in facilitating the conversion of synthetic (virtual) images into high-quality images using a diffusion model.

The system and method are also advantageous for enhancing the applicability of the data to the training and validation of image recognition algorithms for autonomous driving by effectively converting complex images with high object density.

Furthermore, the system and method are advantageous for enabling efficient training and validation by generating data at the level of a real-image domain, while reflecting the shape information (i.e., the target object to be generated) of the synthetic data.

In addition, the system and method are advantageous for improving the reusability of synthetic images by converting them into image data with high diversity.

Moreover, the system and method are advantageous for generating images under various weather conditions by receiving a desired weather condition as input and converting the image into a domain corresponding to that condition.

While preferred embodiments of the present disclosure have been described above, the embodiments disclosed herein are intended to be illustrative and not limiting of the scope of the disclosure.

Accordingly, the technical scope of the disclosure is not limited to the disclosed embodiments but encompasses combinations of the disclosed embodiments, and the scope of the disclosure is not limited by these embodiments.

Furthermore, it will be apparent to those skilled in the art that various changes and modifications can be made to the present disclosure without departing from the spirit or scope of the attached claims, and all such variations and modifications are intended to fall within the scope of the present disclosure.

What is claimed is:

1. A system for generating artificial intelligence (AI) training image data for autonomous driving, the system comprising:
a processor configured to: receive and process synthetic data including shape information of a target object to be generated;
extract segmentation information and edge information from the synthetic data; and
input the extracted segmentation information and edge information into a pre-stored learning model to generate style-transformed image data based on the synthetic data.

2. The system of claim 1, wherein the processor is configured to generate a training dataset by collecting synthetic data including shape information of a target object to be generated using simulations and real image data acquired from a real world,
wherein the system comprises:
a condition processor comprising a conditional encoder configured to extract segmentation information and edge information from the synthetic data in the generated training dataset and encode the extracted segmentation information and edge information, and a control neural network configured to generate control information based on conditional data generated by the conditional encoder;
a reference processor comprising a CLIP encoder configured to encode the real image data in the training dataset to generate reference information; and
a fine-tuning processor configured to fine-tune a stored diffusion model by combining the reference information generated by the reference processing unit with each encoder block of the diffusion model, and combining the conditional data generated by the condition processor with each decoder block of the diffusion model.

3. The system of claim 2, wherein the diffusion model, fully trained by the fine-tuning processor, is stored in the data generation unit and used as the learning model.

4. The system of claim 2, wherein each encoder block of the fine-tuning processor comprises a self-attention layer, a cross-attention layer, and an adaptive instance normalization (AdaIN) layer, and is configured for the reference information, comprising key and value information generated by the reference processor, to be combined with a query in the cross-attention layer and transmitted to the AdaIN layer, and the cross-attention layer generating reference information to be input into the AdaIN layer using an attention map produced through the combination of the query, key, and value information.

5. The system of claim 4, wherein the fine-tuning processor controls image generation by weighting and combining the control information generated by the condition processor with each decoder block.

6. The system of claim 2, wherein the processor generates the training dataset based on preset weather conditions, and the diffusion model, fully trained by the fine-tuning processor, is trained to reflect characteristics of each weather condition.

7. The system of claim 2, wherein the fine-tuning processor calculates a loss function for the generated images and performs training to minimize a loss value of the calculated loss function.

8. A method for generating artificial intelligence (AI) training image data for autonomous driving using an autonomous driving AI training image data generation system including one or more processors performing each operation, the method comprising;
a data input operation of receiving and processing synthetic data including shape information of a target object to be generated;
a data preprocessing operation of extracting segmentation information and edge information from the synthetic data obtained in the data input operation; and
controlling a data generation operation of generating style-transformed image data based on the synthetic data by inputting the segmentation information and edge information extracted in the data preprocessing operation into a pre-stored learning model.

9. The method of claim 8, further comprising a learning model pre-training operation including:
a data collection operation of generating a training dataset by collecting synthetic data including shape information of a target object to be generated using simulations and real image data acquired from a real world;
a condition processing operation of extracting and encoding segmentation information and edge information for the synthetic data within the training dataset generated in the data collection operation, and generating control information based on conditional data generated in the condition processing operation;
a reference processing operation of encoding the real image data within the training dataset generated in the data collection operation to generate reference information; and
a fine-tuning processing operation of fine-tuning a stored diffusion model by combining the reference information generated in the reference processing operation with each encoder block of the diffusion model and combining the control information generated in the condition processing operation with each decoder block of the diffusion model,
wherein the fine-tuning processing operation comprises calculating a loss function for the generated images and performing training to minimize a loss value of the calculated loss function, and the diffusion model, fully trained in the fine-tuning processing operation, is used as the learning model in the data generation operation.

10. The method of claim 9, wherein the fine-tuning processing operation comprises, for each encoder block comprising a self-attention layer, a cross-attention layer, and an adaptive instance normalization (AdaIN) layer, processing the reference information, comprising key and value information generated in the reference processing operation, to be combined with a query in the cross-attention layer and transmitted to the AdaIN layer, cross-attention layer generating reference information to be input into the AdaIN layer using an attention map produced through the combination of the query, key, and value information.

11. The method of claim 10, wherein the fine-tuning processing operation comprises controlling image generation by weighting and combining the control information generated in the condition processing operation with each decoder block.

12. The method of claim 9, wherein the data collection operation comprises generating the training dataset based on preset weather conditions, and the diffusion model, fully trained in the fine-tuning processing operation being trained to reflect characteristics of each weather condition.
